(19) United States
(12) Patent Application Publication
(10) Pub. No.: US 2026/0125275 A1
(43) Pub. Date: May 7, 2026

(54) LITHIUM-CONTAINING OXIDE, ELECTRODE, AND BATTERY

(71) Applicants: SUMITOMO CHEMICAL COMPANY, LIMITED, Chuo-ku, Tokyo (JP); Kyoto University, Kyoto-shi, Kyoto (JP)

(72) Inventors: Tsutomu YAMABAYASHI, Niihama-shi, Ehime (JP); Hiroshi KAGEYAMA, Kyoto-shi, Kyoto (JP)

(21) Appl. No.: 18/869,568

(22) PCT Filed: May 19, 2023
(86) PCT No.: PCT/JP2023/018815

§ 371 Date: Nov. 26, 2024

(30) Foreign Application Priority Data
May 30, 2022 (JP) 2022-088039
Nov. 4, 2022 (JP) 2022-177543

(51) Int. Cl. C01G 45/1228; H01M 4/485; H01M 4/505

(52) U.S. Cl. CPC C01G 45/1228; H01M 4/485; H01M 4/505; C01P 2002/72; C01P 2002/86; C01P 2002/90; C01P 2004/04; C01P 2006/40

(57) ABSTRACT

A lithium-containing oxide having a cationic-disordered rock salt-type structure,
in which, when a solid ⁷Li-NMR spectrum has been measured, a signal 1 having a half width of more than 0 ppm and 40 ppm or less and a signal 2 having a half width of more than 100 ppm and 2000 ppm or less are observed in a range of a chemical shift of −3000 to 3000 ppm for which a peak of a 1 mol/L LiCl aqueous solution is set to 0 ppm, and
an integrated intensity of the signal 1 relative to a total of integrated intensities of the signal 1 and the signal 2 is more than 0% and 60% or less.

### TECHNICAL FIELD

The present disclosure relates to a lithium-containing oxide, an electrode, and a battery.

### BACKGROUND ART

Secondary batteries performing charging and discharging by migrating alkali metal ions between the positive electrode and the negative electrode are known. Among such secondary batteries, lithium ion secondary batteries are typical, have been already put into practical use as small power supplies for mobile phones or laptops, and furthermore, can be used as large power supplies such as automotive power supplies for electric vehicles or hybrid vehicles or power supplies for distributed energy storage, and the demand thereof is increasing.

As positive electrode materials of lithium ion secondary batteries, lithium-containing oxides such as Li_{1.2}Mn_{0.4}Ti_{0.4}O₂ or Li_{1.3}Mn_{0.4}Nb_{0.3}O₂ having a cationic-disordered rock salt-type crystal structure are known.

Compared with conventional lithium-containing lamellar oxides such as LiCoO₂, cationic-disordered lithium-containing compositions enable an increase in the lithium content proportion in the composition and become positive electrode materials having a high energy density. In addition, cationic-disordered lithium-containing oxides and oxyfluorides in which a low-valency transition metal such as Mn²⁺ and a high-valency transition metal such as V⁴⁺ are combined together, and furthermore, cationic-disordered lithium-containing oxides into which a lithium salt such as Li₂SO₄ has been introduced are also known (Non Patent Literature 1 and Patent Literature 1 to 3).

### CITATION LIST

### Patent Literature

[Patent Literature 1] Japanese Unexamined Patent Application Publication No. 2018-92958
[Patent Literature 2] Japanese Unexamined Patent Application Publication No. 2020-534234
[Patent Literature 3] WO 2017/169599

### Non Patent Literature

[Non Patent Literature 1] Nature Communications 7, Article Number: 13814 (2016)

### SUMMARY OF INVENTION

### Technical Problem

Here, conventional cationic-disordered lithium-containing oxides have a large voltage hysteresis or irreversible capacity between charging and discharging and have a low energy efficiency between charging and discharging.

The present disclosure has been made in consideration of the above circumstance, and an objective of the present disclosure is to provide a cationic-disordered lithium-containing oxide having a high energy efficiency and an electrode and a battery in which the cationic-disordered lithium-containing oxide is used.

### Solution to Problem

The present disclosure includes the following embodiments [1] to [11].
[1] A lithium-containing oxide having a cationic-disordered rock salt-type structure, in which, when a solid ⁷Li-NMR spectrum has been measured, a signal 1 having a half width of more than 0 ppm and 40 ppm or less and a signal 2 having a half width of more than 100 ppm and 2000 ppm or less are observed in a range of a chemical shift of −3000 to 3000 ppm for which a peak of a 1 mol/L LiCl aqueous solution is set to 0 ppm, and
an integrated intensity of the signal 1 relative to a total of integrated intensities of the signal 1 and the signal 2 is more than 0% and 60% or less.
[2] The lithium-containing oxide of [1] represented by a formula: LiₓM′ₐM″_{b}Z_{c}O₂₋ₑX_{d}, in the formula, 1<x≤1.40, 0.55≤a≤0.90, 0.05≤b≤0.22, 1.8≤x+a+b≤2.2, 0≤c≤0.20, 0≤d<0.70, 0≤e<0.70, M′ is at least one element selected from the group consisting of Cr, Mn, Fe, Co, Ni and Cu, M″ is Si or two or more elements of Si and at least one element selected from P, S, V and Ge, Z is an element except Li, O, M′, M″ and halogen, and X is a halogen element.
[3] The lithium-containing oxide of [1] represented by a formula: LiₓM′ₐM″_{b}Z_{c}O₂₋ₑX_{d}, in the formula, 1<x≤1.30, 0.4≤a≤0.85, 0.05≤b≤0.30, 1.8≤x+a+b≤2.2, 0≤c≤0.20, 0≤d<0.70, 0≤e<0.70, M′ is at least one element selected from the group consisting of Cr, Mn, Fe, Co, Ni and Cu, M″ is V or two or more elements of V and at least one element selected from P, S, Si and Ge, Z is an element except Li, O, M′, M″ and halogen, and X is a halogen element.
[4] The lithium-containing oxide of [1] represented by a formula: LiₓM′ₐM″_{b}Z_{c}O₂₋ₑX_{d}, in the formula, 1<x≤1.40, 0.55≤a≤0.90, 0.05≤b≤0.22, 1.8≤x+a+b≤2.2, 0≤c≤0.20, 0≤d<0.70, 0≤e<0.70, M′ is at least one element selected from the group consisting of Cr, Mn, Fe, Co, Ni and Cu, M″ is Ge or two or more elements of Ge and at least one element selected from P, S, Si and V, Z is an element except Li, O, M′, M″ and halogen, and X is a halogen element.
[5] The lithium-containing oxide of [1] represented by a formula: LiₓM′ₐM″_{b}Z_{c}O₂₋ₑX_{d}, in the formula, 1<x≤1.30, 0.4≤a≤0.85, 0.05≤b≤0.30, 1.8≤x+a+b≤2.2, 0≤c≤0.20, 0≤d<0.70, 0≤e<0.70, M′ is at least one element selected from the group consisting of Cr, Mn, Fe, Co, Ni and Cu, M″ is at least two or more selected from the group consisting of Si, P, S, V and Ge, Z is an element except Li, O, M′, M″ and halogen, and X is a halogen element.
[6] The lithium-containing oxide of any one of [1] to [5], in which, in powder X-ray diffraction measurement using a CuKα ray at 25° C., a half width of a peak that is observed in a 2θ range of 42° to 46° is 0.50 to 50.
[7] A lithium-containing oxide containing 8 to 12 mass % of Li, 35 to 56 mass % of M′ that is at least one element selected from the group consisting of Cr, Mn, Fe, Co, Ni and Cu and more than 0 mass % and 15 mass % or less of M″ that is at least one element selected from the group consisting of Si, P, S, V and Ge, in which, in powder X-ray diffraction measurement using a CuKα ray at 25° C., a diffraction pattern derived from a cationic-disordered rock salt-type structure is observed, when a solid ⁷Li-NMR spectrum has been measured, a signal 1 having a half width of more than 0 ppm and 40 ppm or less and a signal 2 having a half width of more than 100 ppm and 2000 ppm or less are observed in a range of a chemical shift of −3000 to 3000 ppm for which a peak of a 1 mol/L LiCl aqueous solution is set to 0 ppm, and
an integrated intensity of the signal 1 relative to a total of integrated intensities of the signal 1 and the signal 2 is more than 0% and 60% or less.
[8] The lithium-containing oxide of any one of [1] to [7], having an amorphous phase.
[9] An electrode containing the lithium-containing oxide of any one of [1] to [8].
[10] A non-aqueous secondary battery including the electrode described in [9].
[11] A lithium-containing oxide having a crystal phase of a cationic-disordered rock salt-type structure and an amorphous phase,
in which, when a solid ⁷Li-NMR spectrum has been measured, a signal 1 having a half width of more than 0 ppm and 40 ppm or less and a signal 2 having a half width of more than 100 ppm and 2000 ppm or less are observed in a range of a chemical shift of −3000 to 3000 ppm for which a peak of a 1 mol/L LiCl aqueous solution is set to 0 ppm, and
an integrated intensity of the signal 1 relative to a total of integrated intensities of the signal 1 and the signal 2 is more than 0% and 60% or less.

### Advantageous Effects of Invention

According to the present disclosure, it is possible to provide a cationic-disordered lithium-containing oxide having a high energy efficiency and an electrode and a battery in which the cationic-disordered lithium-containing oxide is used.

### BRIEF DESCRIPTION OF DRAWINGS

FIG. 1 is a view showing solid ⁷Li-NMR spectra of lithium-containing oxides of Examples 1 to 3 and Comparative Example 1.

FIG. 2 is a view showing an electron diffraction image of a sample of Example 2.

FIG. 3 is a view showing dark field observation images of the sample of Example 2 with a transmission electron microscope.

### DESCRIPTION OF EMBODIMENTS

A lithium-containing oxide according to one embodiment of the present disclosure has a cationic-disordered rock salt-type structure, when a solid ⁷Li-NMR spectrum has been measured, a signal 1 having a half width of more than 0 ppm and 40 ppm or less and a signal 2 having a half width of more than 100 ppm and 2000 ppm or less are observed in a range of a chemical shift of −3000 to 3000 ppm for which a peak of a 1 mol/L LiCl aqueous solution is set to 0 ppm, and the integrated intensity of the signal 1 relative to the total of the integrated intensities of the signal 1 and the signal 2 is more than 0% and 60% or less. According to such a lithium-containing oxide, the voltage hysteresis and the irreversible capacity between charging and discharging are small, and the energy efficiency between charging and discharging improves. In addition, in the present specification, unless particularly otherwise described, the chemical shift in the solid ⁷Li-NMR spectrum means a chemical shift for which the peak of a 1 mol/L LiCl aqueous solution is set to 0 ppm.

In the present specification, the half width means full width at half maximum. In addition, in the present specification, the integral ratio of the signal 1 and the integral ratio of the signal 2 refer to the integrated intensities (%) of the signal 1 and the signal 2 relative to the total of the integrated intensities of the signal 1 and the signal 2, respectively.

The half width of the signal 1 may be 35 ppm or less, 30 ppm or less, 25 ppm or less or 20 ppm or less and may be 0.01 ppm or more or 0.1 ppm or more. In addition, the half width of the signal 1 may be 0.01 to 40 ppm, may be 0.01 to 35 ppm or may be 0.1 to 30 ppm

The signal 1 may be a signal that is observed at −1000 to 1000 ppm, −500 to 500 ppm, −100 to 100 ppm, −50 to 50 ppm or −10 to 50 ppm regarding the chemical shift.

The signal 1 has a half width and a chemical shift in the above ranges and may have one or more peaks. In a case where two or more signals 1 are observed, the signals may be observed in two regions of a range of −20 to 10 ppm and more than 10 ppm and 50 ppm or less regarding the chemical shift. Here, the signal that is observed in the chemical shift range of −20 to 10 ppm is referred to as a signal 1-1, and the signal that is observed in the chemical shift range of more than 10 ppm and 60 ppm or less is referred to as a signal 1-2.

The signal 1-1 may be a signal that is observed at −15 to 8 ppm, −10 to 5 ppm or −5 to 3 ppm regarding the chemical shift. The half width of the signal 1-1 may be 35 ppm or less, 30 ppm or less, 25 ppm or less or 20 ppm or less and may be 0.01 ppm or more or 0.1 ppm or more. In addition, the half width of the signal 1-1 may be 0.01 to 40 ppm, may be 0.01 to 35 ppm or may be 0.1 to 30 ppm.

The signal 1-2 may be a signal that is observed at 15 to 50 ppm, 25 to 45 ppm or 30 to 40 ppm regarding the chemical shift. The half width of the signal 1-2 may be 35 ppm or less, 30 ppm or less, 25 ppm or less or 20 ppm or less and may be 0.01 ppm or more or 0.1 ppm or more. In addition, the half width of the signal 1-2 may be 0.01 to 40 ppm, may be 0.01 to 35 ppm or may be 0.1 to 30 ppm.

The integral ratio of the signal 1 may be 50% or less, 40% or less, 30% or less, 20% or less or 15% or less, may be 0.01% or more or 0.1% or more and may be 0.01% to 50%, 0.01% to 40%, 0.1% to 30% or 0.3 to 20%.

In a case where both the signal 1-1 and the signal 1-2 are observed, the integral ratio of the signal 1-1 may be 40% or less, 30% or less, 20% or less or 15% or less, may be 0.01% or more or 0.1% or more and may be 0.01% to 40%, 0.01% to 30%, 0.1% to 20% or 0.3 to 15%. In a case where both the signal 1-1 and the signal 1-2 are observed, the integral ratios of the signal 1-1 and the signal 1-2 are the proportions (%) of the integrated intensities of the signal 1-1 and the signal 1-2 relative to the total of the integrated intensities of the signal 1-1, the signal 1-2 and the signal 2, respectively.

In a case where both the signal 1-1 and the signal 1-2 are observed, the integral ratio of the signal 1-2 may be 30% or less, 20% or less, 15% or less, 10% or less or 5% or less, may be 0.01% or more or 0.1% or more and may be 0.01% to 30%, 0.01% to 20%, 0.1% to 15% or 0.3 to 10%.

The half width of the signal 2 may be 150 to 1800 ppm, 200 to 1500 ppm or 250 to 1300 ppm.

The signal 2 may be a signal that is observed at a chemical shift of −1000 to 1000 ppm, −500 to 900 ppm, −300 to 800 ppm, −200 to 700 ppm or −150 to 600 ppm.

The signal 2 has a half width and a chemical shift in the above ranges and may have one or more peaks.

The lithium-containing oxide of the present embodiment may be represented by the following formula (1).

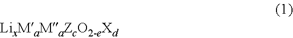

In the formula (1), x is 1<x≤1.40 and may be 1.03≤x≤1.36.

In the formula (1), a is 0.40≤a≤0.90, may be 0.45≤a≤0.87 or may be 0.50≤a≤0.85.

In the formula (1), b is 0.01≤b≤0.35, may be 0.05≤b≤0.30 or may be 0.07≤b≤0.25.

In addition, 2≤x+a+b≤2.2 is satisfied.

In the formula (1), 0≤c≤0.20, 0≤d<0.70 and 0≤e<0.70 are satisfied.

In the formula (1), M′ includes at least one element selected from the group consisting of Cr, Mn, Fe, Co, Ni and Cu. M″ is at least one element selected from the group consisting of Si, P, S, V and Ge;

In the formula (1), Z is an element except Li, O, M′, M″ and halogen, and X is a halogen element.

The lithium-containing oxide of the present embodiment may have an amorphous phase together with a crystal phase. The crystal phase may have been dispersed in the amorphous phase. When the amorphous phase is present, there is a tendency that the diffusion of lithium ions in the material improves. The lithium-containing oxide of the present embodiment may have a crystal phase (crystallite) having an average particle diameter of 1 to 30 nm in terms of equivalent circle diameter. The average particle diameter of the crystal phase may be 1 to 20 nm or may be 1 to 15 nm in terms of equivalent circle diameter. Here, the amorphous phase can be confirmed by observation with a transmission electron microscope (TEM).

The lithium-containing oxide of the present embodiment may contain 8 to 12 mass % of Li, 35 to 56 mass % of M′, which is at least one element selected from the group consisting of Cr, Mn, Fe, Co, Ni and Cu, and more than 0 mass % and 15 mass % or less of M″, which is at least one element selected from the group consisting of Si, P, S, V and Ge. Such a lithium-containing oxide may contain an element except Li, O, M′, M″ and halogen aside from the Li, M′ and M″. Such an element may be, for example, an alkali metal element except Li, an element of Group II to Group XVI in the periodic table and a halogen element. Examples of the alkali metal element except Li include Na, K, Rb and Cs. The element of Group II to Group XVI in the periodic table may be a metal element, and examples thereof include Al and the like. The halogen element may include at least one element selected from the group consisting of F, Cl, Br and I, may include at least one of F and Cl and may include F. The content of the halogen element may be 5 mass % or less relative to the total amount of the lithium-containing oxide. The lithium-containing oxide of the present embodiment may not be a single phase. That is, a lithium-containing oxide except the lithium-containing oxide having a cationic-disordered rock salt-type structure may be contained. Therefore, in powder X-ray diffraction measurement using a CuKα ray at 25° C., a different diffraction pattern may be observed together with a diffraction pattern derived from the cationic-disordered rock salt-type structure. The lithium-containing oxide may have an amorphous phase together with a crystal phase (crystallite).

The content of Li in the lithium-containing oxide of the present embodiment may be 8.05 to 11.6 mass % or may be 8.1 to 11.4 mass %. The content of M′ in the lithium-containing oxide of the present embodiment may be 35.5 to 54 mass % or may be 36 to 53 mass %. The content of M″ in the lithium-containing oxide of the present embodiment may be 1 to 15 mass % or may be 2 to 14.5 mass %. The lithium-containing oxide of the present embodiment may contain 1 to 10 mass % of at least one of Si and P, may contain 1.5 to 8.5 mass % or may contain 2 to 7 mass %.

M″ may include Si. That is, M″ may be Si or two or more elements of Si and at least one element selected from the group consisting of P, S, V and Ge. In this case, in the formula (1), 1<x≤1.40, 0.55≤a≤0.90, 0.05≤b≤0.22 and 1.8≤x+a+b≤2.2 need to be satisfied.

M″ may include V. That is, M″ may be V or two or more of V and at least one element selected from the group consisting of Si, P, S and Ge. In this case, in the formula (1), 1<x≤1.30, 0.4≤a≤0.85, 0.05≤b≤0.30, 1.8≤x+a+b≤2.2 need to be satisfied. V may be pentavalent.

M″ may include Ge. That is, M″ may be Ge or two or more of Ge and at least one element selected from the group consisting of Si, P, S and V. In this case, in the formula (1), 1<x≤1.30, 0.4≤a≤0.85, 0.05≤b≤0.30, 1.8≤x+a+b≤2.2 need to be satisfied. Ge may be tetravalent.

M″ may include at least two or more selected from the group consisting of Si, P, S, V and Ge or may include at least one of Si and P. In this case, in the formula (1), 1<x≤1.30, 0.4≤a≤0.85, 0.05≤b≤0.30, 1.8≤x+a+b≤2.2 need to be satisfied.

In the formula (1), Z may be, for example, an alkali metal element except Li and an element of Group II to Group XVI in the periodic table. Examples of Z include Na, K, Rb, Cs, Al, Mg, Ca, Zr, Nb, Mo, Ru, W, Sn and the like. Z may be a metal element.

In the formula (1), c may be 0.10 or less, may be 0.05 or less, may be 0.01 or less and may be substantially zero.

In the formula (1), X may include at least one element selected from the group consisting of F, Cl, Br and I, may include at least one of F and Cl and may include F.

In the formula (1), d may be 0.60 or less, may be 0.40 or less, may be 0.20 or less, may be 0.10 or less, may be 0.05 or less, may be 0.01 or less and may be substantially zero. d may be 0.001 or more. In addition, d may be 0.001 to 0.6, may be 0.001 to 0.4 or may be 0.001 to 0.2. e may be 0.60 or less, may be 0.40 or less, may be 0.20 or less, may be 0.10 or less, may be 0.05 or less, may be 0.01 or less and may be substantially zero. e may be 0.001 or more. In addition, e may be 0.001 to 0.6, may be 0.001 to 0.4 or may be 0.001 to 0.2.

In the lithium-containing oxide of the present embodiment, in powder X-ray diffraction measurement using a CuKα ray, a diffraction pattern belonging to the cationic-disordered rock salt-type structure having a characteristic of a crystal space group Fm-3m may be observed, and the half width of a peak that is observed in a 2θ range of 42° to 46° may be 0.5° to 5°. In the cationic-disordered rock salt-type structure having a characteristic of a crystal space group Fm-3m, the peak that is observed in the 2θ range of 42° to 46° is derived from the reflection of a (200) plane.

A method for producing the lithium-containing oxide is not particularly limited, and examples thereof include a method in which an oxide containing Li and M′ and having a rock salt composition (rock salt composition oxide) and a lithium salt containing M″ are mechanochemically mixed together with a ball mill. Examples of the rock salt composition oxide include LiCrO₂, LiMnO₂, LiFeO₂, LiCoO₂, LiNiO₂ and LiCuO₂. Examples of the lithium salt include LiVO₄, Li₄SiO₄, Li₂SiO₃, Li₃P_{0.5}V_{0.5}O₄, Li_{3.5}Si_{0.5}P_{0.5}O₄, Li₄GeO₄, Li₃PO₄ and the like. The ball milling conditions are not particularly limited, the rotation speed may be 100 to 700 rpm, and the mixing time may be 0.5 to 72 hours.

The lithium-containing oxide of the present embodiment can be used as a material for batteries (lithium ion batteries and the like). That is, a battery of the present embodiment contains the lithium-containing oxide. The battery may be a primary battery or a secondary battery. In addition, the battery may be a non-aqueous battery. In the battery, the lithium-containing oxide may be contained in an electrode.

The battery of the present embodiment has a positive electrode, a negative electrode and an electrolyte disposed between the positive electrode and the negative electrode.

A positive electrode of the present embodiment contains a positive electrode active substance. The positive electrode active substance of the present embodiment contains the lithium-containing oxide of the present embodiment. The positive electrode contains a current collector and a positive electrode mixture supported on the current collector. The positive electrode mixture may form a positive electrode mixture layer on the current collector.

The positive electrode mixture contains the positive electrode active substance and may contain a conductive material, a binder or the like as necessary.

Examples of the conductive material include carbon materials such as natural graphite, artificial graphite, cokes, carbon black and the like. Examples of the binder include thermoplastic resins, and specific examples thereof include fluororesins such as polyvinylidene fluoride (hereinafter, also referred to as “PVDF”), polytetrafluoroethylene, tetrafluoroethylene-hexafluoropropylene-vinylidene fluoride-based copolymers, hexafluoropropylene-vinylidene fluoride-based copolymers, and tetrafluoroethylene-perfluorovinyl ether-based copolymers; polyolefin resins such as polyethylene and polypropylene; and the like. As the current collector, Al, Ni, stainless steel and the like can be used.

Examples of a method for supporting the positive electrode mixture on the current collector include a pressure molding method, a method in which an electrode mixture is made into a paste using an organic solvent or the like, and the paste is applied onto a current collector, dried and fixed by pressing or the like and the like. In the case of making the electrode mixture into a paste, for example, a slurry composed of the positive electrode active substance, a conductive material, a binder and an organic solvent is produced. Examples of the organic solvent include amine-based solvents such as N,N-dimethylaminopropylamine and diethyltriamine; ether-based solvents such as ethylene oxide and tetrahydrofuran; ketone-based solvents such as methyl ethyl ketone; ester-based solvents such as methyl acetate; aprotic polar solvents such as dimethylacetamide and N-methyl-2-pyrrolidone and the like. Examples of a method for applying the electrode mixture to the current collector include a slit die application method, a screen application method, a curtain application method, a knife application method, a gravure application method, an electrostatic spray method and the like.

The negative electrode of the battery is not particularly limited and may be an electrode containing a negative electrode active substance and containing a conductive auxiliary agent, a binding agent or the like as necessary. Examples of a negative electrode active substance of a lithium ion battery include pure elements such as Li, Si, P, Sn, Si—Mn, Si—Co, Si—Ni, In and Au, alloys or complexes containing the above elements, carbon materials such as graphite, substances containing lithium ions inserted between layers of the carbon material and the like.

The electrolyte of the battery is not particularly limited, and an electrolytic solution obtained by dissolving an alkali metal salt in an organic solvent can be used. In addition, the electrolyte may be a solid electrolyte. Examples of the alkali metal salt include iodide salts, tetrafluoroborate salts, hexafluorophosphate salts, bis(fluorosulfonyl)imide salts, bis(trifluoromethylsulfonyl)imide salts and the like.

The organic solvent that is contained in the electrolytic solution is not particularly limited, and examples thereof include non-aqueous solvents, for example, cyclic carbonate esters such as ethylene carbonate (EC) or propylene carbonate (PC), linear carbonate esters such as dimethyl carbonate (DMC), diethyl carbonate (DEC), or ethyl methyl carbonate (EMC), sultones and the like. The solvent may be singly used or two or more solvents may be used in combination.

### Example 1

LiMnO₂ was obtained by mixing lithium carbonate (manufactured by Fujifilm Wako Pure Chemical Corporation) and manganese (III) oxide (manufactured by Fujifilm Wako Pure Chemical Corporation) in a mole ratio of 1:1 and firing the mixture at 900° C. in an argon atmosphere for 12 hours. Li₃VO₄ was obtained by mixing lithium carbonate (manufactured by Fujifilm Wako Pure Chemical Corporation) and vanadium (V) oxide (manufactured by Fujifilm Wako Pure Chemical Corporation) in a mole ratio of 3:1 and firing the mixture at 650° C. in the atmosphere for 12 hours. The LiMnO₂ powder and the Li₃VO₄ powder were mixed together in a mole ratio of 0.9:0.1 and introduced into a zirconia ball mill container so that the mass ratio of zirconia balls having a diameter of 4 mm and the powder mixture reached 65:1. The ball mill container was introduced in a planetary ball mill device (manufactured by Retsch GmbH, PM200), and ball milling was performed at a rotation speed of 500 rpm for 48 hours, thereby obtaining a cationic-disordered lithium-containing oxide.

### Examples 2 to 11 and Comparative Examples 1 to 4

Raw materials were obtained as described below.

Li₄SiO₄ was obtained by mixing lithium carbonate (manufactured by Fujifilm Wako Pure Chemical Corporation) and silicon dioxide (manufactured by Fujifilm Wako Pure Chemical Corporation) in a mole ratio of 2:1 and firing the mixture in the atmosphere at 900° C. for four hours.

As Li₂SiO₃, a reagent manufactured by Kojundo Chemical Lab. Co., Ltd. was used.

Li₄GeO₄ was obtained by mixing lithium carbonate (manufactured by Fujifilm Wako Pure Chemical Corporation) and germanium oxide (manufactured by Kojundo Chemical Lab. Co., Ltd.) in a mole ratio of 2:1 and firing the mixture in the atmosphere at 650° C. for 12 hours.

Li₃P_{0.5}V_{0.5}O₄ was obtained by mixing lithium carbonate (manufactured by Fujifilm Wako Pure Chemical Corporation), diammonium hydrogenphosphate (manufactured by Fujifilm Wako Pure Chemical Corporation) and vanadium (V) oxide in a mole ratio of 6:2:1 and firing the mixture in the atmosphere at 800° C. for 10 hours.

Li_{3.5}Si_{0.5}P_{0.5}O₄ was obtained by mixing lithium carbonate (manufactured by Fujifilm Wako Pure Chemical Corporation), Li₃PO₄ and silicon dioxide (manufactured by Fujifilm Wako Pure Chemical Corporation) in a mole ratio of 2:1:1 and firing the mixture in an argon atmosphere at 900° C. for 10 hours.

Li₃PO₄ was obtained by dissolving lithium hydroxide (manufactured by Fujifilm Wako Pure Chemical Corporation) and diammonium hydrogenphosphate (manufactured by Fujifilm Wako Pure Chemical Corporation) in an ion exchange water so that the mole ratio reached 3:1, filtering the generated precipitate and drying the precipitate at 80° C.

LiCrO₂ was obtained by mixing lithium carbonate (manufactured by Fujifilm Wako Pure Chemical Corporation) and chromium (III) oxide (manufactured by Fujifilm Wako Pure Chemical Corporation) in a mole ratio of 1:1 and firing the mixture in an argon atmosphere at 800° C. for 15 hours.

Li_{1.2}Mn_{0.5}Ti_{0.3}O₂ was obtained by weighing lithium carbonate (manufactured by Fujifilm Wako Pure Chemical Corporation), manganese (III) oxide (manufactured by Fujifilm Wako Pure Chemical Corporation), manganese (IV) oxide and TiO₂ (manufactured by Fujifilm Wako Pure Chemical Corporation) so that the mole ratio reached 6:2:1:3, mixing these together with ethanol and zirconia balls having a diameter of 8 mm with a wet-type ball mill and firing the powder mixture after filtration and drying in an argon atmosphere at 900° C. for 12 hours.

The above raw materials were used, the formulations were changed as shown in Table 1, and ball milling was performed under the same conditions as in Example 1 except Comparative Example 3, whereby lithium-containing oxides were produced.

### <Charge/Discharge Test>

### (1) Production of Positive Electrode

Each lithium-containing compound of the examples and the comparative examples except Comparative Example 3, acetylene black (trade name: HS-100, manufactured by Denka Company Limited.) as a conductive material and polytetrafluoroethylene (PTFE, model No.: 6-J, Chemours-Mitsui Fluoroproducts Co., Ltd.) as a binder were each weighed so as to prepare a composition of the positive electrode active substance/the conductive material/the binder=70:20:10 (mass ratio). In addition, the positive electrode active substance and the conductive material were sufficiently mixed together with an agate mortar, the binder was added thereto, and the components were further mixed together. Seven milligrams of a mixture was weighed and stretched out in a circle on the mortar. The stretched mixture was pressure-bonded to a 110 m-thick aluminum mesh (100 meshes, manufactured by The Nilaco Corporation), which was a current collector, to obtain a positive electrode containing the positive electrode active substance.

Regarding Comparative Example 3, Li_{1.2}Mn_{0.5}Ti_{0.3}O₂ and acetylene black (trade name: HS-100, manufactured by Denka Company Limited.) were weighed so that the mass ratio reached 9:1, and ball milling was performed at a rotation speed of 500 rpm for nine hours together with zirconia balls having a diameter of 8 mm. The powder mixture, acetylene black and a N-methyl-2-pyrrolidone (NMP) solution of PVDF (KF polymer, model No.: L #1120, manufactured by Kureha Corporation) as a binder were added and kneaded in proportions in which a composition of the positive electrode active substance/the acetylene black/PVDF with a (mass ratio) of 72:18:10, whereby adjusting a paste-like positive electrode mixture was obtained. During the preparation of the positive electrode mixture, the viscosity of the paste was adjusted by adding NMP. The obtained positive electrode mixture was applied to a m-thick Al foil, which served as a current collector, dried in the atmosphere at 60° C. for one hour, and then dried in a vacuum at 150° C. for eight hours, thereby obtaining a positive electrode.

### (2) Production and Evaluation of Li Half Cell

A coin-type battery CR2032 type was assembled using the positive electrode, a polyethylene porous film (thickness: 16 m) as a separator, a 1 M LiPF₆ solution (a solvent was a solvent mixture containing ethylene carbonate (EC), dimethyl carbonate (DMC) and ethyl methyl carbonate (EMC) in a volume ratio of 30:35:35) as a non-aqueous electrolytic solution and metallic lithium as an auxiliary electrode. The battery was assembled in a globe box in an argon atmosphere. Charge/discharge tests were performed using the produced coin-type batteries at 25° C. within a voltage range of 1.5 to 4.8 V under the following conditions. From the results of the charge/discharge tests, charge/discharge curves in which the battery capacity (mAh/g) was indicated along the abscissa and the battery voltage (V vs. Li/Li⁺) was indicated along the ordinate were created, regarding during the charging and during the discharging, the areas of regions surrounded by the curve and the abscissa were obtained, respectively, and the charge energy densities and the discharge energy densities were calculated. The measurement results of the initial discharge energy densities and the energy efficiencies (the ratios (%) of the discharge energy density to the charge energy density) are shown in Table 1.

Charge/discharge conditions: Constant-current constant-voltage charging (CC-CV) charging was performed at 30 mA/g and a cut-off condition of 6 mA/g.

Condition during discharging: Constant-current (CC) discharging was performed at 30 mA/g.

TABLE 1

| | | | | | Discharge | Energy |
|---|---|---|---|---|---|---|
| | Rock salt-type oxide | | Lithium salt | | energy density | efficiency |
| | Mole ratio | Compound | Mole ratio | Compound | (Wh/Kg) | (%) |
| Example 1 | 0.9 | LiMnO₂ | 0.1 | Li₃VO₄ | 799 | 73.6 |
| Example 2 | 0.8 | | 0.2 | | 925 | 64.3 |
| Example 3 | 0.7 | | 0.3 | | 910 | 60.4 |
| Example 4 | 0.9 | | 0.1 | Li₄SiO₄ | 906 | 74.5 |
| Example 5 | 0.8 | | 0.2 | | 882 | 63.8 |
| Example 6 | 0.9 | | 0.1 | Li₂SiO₃ | 789 | 84.2 |
| Example 7 | 0.8 | | 0.2 | | 720 | 72.2 |
| Example 8 | 0.8 | | 0.2 | Li₄GeO₄ | 1025 | 72.4 |
| Example 9 | 0.8 | | 0.2 | Li₃P_{0.5}V_{0.5}O₄ | 985 | 76.4 |
| Example 10 | 0.8 | | 0.2 | Li_{3.5}Si_{0.5}P_{0.5}O₄ | 1006 | 73.5 |
| Example 11 | 0.8 | LiCrO₂ | 0.2 | Li₃VO₄ | 912 | 74.2 |
| Comparative Example 1 | 1 | LiMnO₂ | — | | 527 | 59.8 |
| Comparative Example 2 | 1 | LiCrO₂ | — | | 356 | 39.8 |
| Comparative Example 3 | 1 | Li_{1.2}Mn_{0.5}Ti_{0.3}O₂ | — | | 669 | 47.1 |
| Comparative Example 4 | 0.7 | LiMnO₂ | 0.3 | Li₄SiO₄ | 636 | 36.5 |

### <Solid ⁷Li-NMR Measurement>

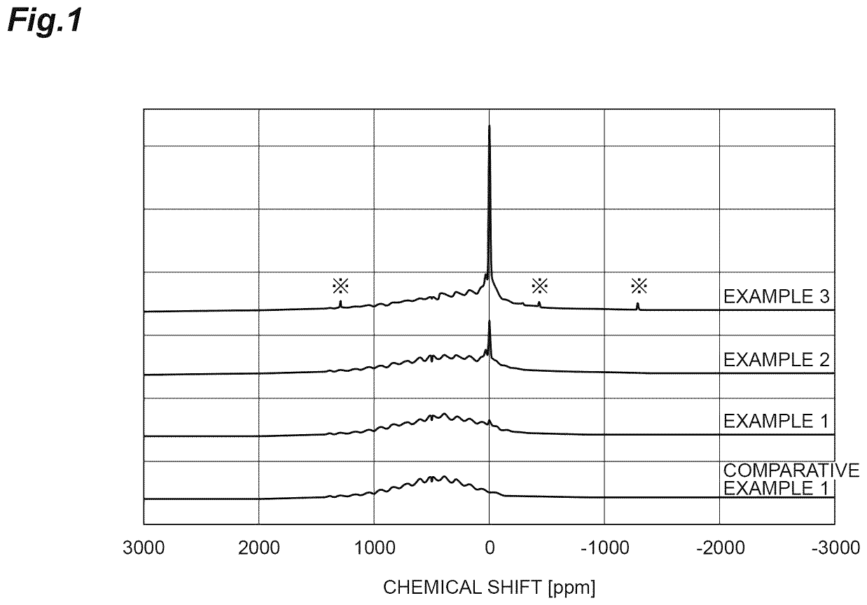

For each lithium-containing oxide obtained in the examples and the comparative examples, solid ⁷Li-NMR measurement was performed at room temperature (25° C.) under the following conditions. The results are shown in Table 2 and Table 3. Here, a signal 1 refers to a signal that is derived from lithium relatively weakly affected by a paramagnetic component in a sample and has a half width of more than 0 ppm and 40 ppm or less, and a signal 2 refers to a signal that is derived from Li relatively strongly affected by the paramagnetic component in the sample and has a half width of more than 100 ppm and 2000 ppm or less. In Table 2 and Table 3, signal integral ratios indicate the proportions (%) of the integrated intensity of each signal relative to the total of the integrated intensities of the signal 1 and the signal 2. The integrated intensity of each signal was calculated after curve fitting was performed with a Gaussian function and the signal was separated. The solid ⁷Li-NMR spectra of the lithium-containing oxides of Examples 1 to 3 and Comparative Example 1 are shown in FIG. 1. In FIG. 1, signals with * are spinning sidebands that could not be suppressed.

As a pretreatment, approximately 6 mg of an analysis sample was packed into a zirconia rotor having 1.3 mmφ.

The solid ⁷Li-NMR measurement is as described below.
Spectrometer: AVANCE300 (manufactured by Bruker)
Observation core: 7Li (resonant frequency 117 MHz)
Measurement method: MATPASS method
MAS condition: 50 kHz
Waiting time: 0.2 seconds
Accumulation count: 81920 times
Measurement temperature: 25° C.
Standard substance: 1 mol/L LiCl aqueous solution

TABLE 2

| Analysis sample | | | | | | | |
|---|---|---|---|---|---|---|---|
| (composition) | | Signal 1-1 | | Signal 1-2 | | Signal 2 | |
| Example 1 | Signal integral ratio | 1% | | | | 99% | |
| (0.9LiMnO₂•0.1Li₃VO₄) | Chemical shift | −1 | ppm | | | 392 | ppm |
| | Half width | 15 | ppm | | | 817 | ppm |
| Example 2 | Signal integral ratio | 4% | | 1% | | 94% | |
| (0.8LiMnO₂•0.2Li₃VO₄) | Chemical shift | −1 | ppm | 36 | ppm | 363 | ppm |
| | Half width | 15 | ppm | 15 | ppm | 909 | ppm |
| Example 3 | Signal integral ratio | 12% | | 2% | | 86% | |
| (0.7LiMnO₂•0.3Li₃VO₄) | Chemical shift | −1 | ppm | 35 | ppm | 195 | ppm |
| | Half width | 12 | ppm | 15 | ppm | 815 | ppm |
| Example 4 | Signal integral ratio | 1% | | | | 99% | |
| (0.9LiMnO₂•0.1Li₄SiO₄) | Chemical shift | 1 | ppm | | | 257 | ppm |
| | Half width | 15 | ppm | | | 874 | ppm |
| Example 5 | Signal integral ratio | 6% | | | | 94% | |
| (0.8LiMnO₂•0.2Li₄SiO₄) | Chemical shift | 1 | ppm | | | 205 | ppm |
| | Half width | 15 | ppm | | | 1140 | ppm |
| Example 6 | Signal integral ratio | 1% | | | | 99% | |
| (0.9LiMnO₂•0.1Li₂SiO₃) | Chemical shift | −2 | ppm | | | 313 | ppm |
| | Half width | 11 | ppm | | | 782 | ppm |
| Example 7 | Signal integral ratio | 4% | | | | 96% | |
| (0.8LiMnO₂•0.2Li₂SiO₃) | Chemical shift | −2 | ppm | | | 178 | ppm |
| | Half width | 15 | ppm | | | 728 | ppm |
| Example 8 | Signal integral ratio | 9% | | 1% | | 90% | |
| (0.8LiMnO₂•0.2Li₄GeO₄) | Chemical shift | −1 | ppm | 35 | ppm | 184 | ppm |
| | Half width | 9 | ppm | 9 | ppm | 761 | ppm |
| Example 9 | Signal integral ratio | 11 | ppm | | | 89% | |
| (0.8LiMnO₂•0.2Li₃V_{0.5}P_{0.5}O₄) | Chemical shift | −2 | ppm | | | 328 | ppm |
| | Half width | 14 | ppm | | | 1103 | ppm |
| Example 10 | Signal integral ratio | 13% | | | | 87% | |
| (0.8LiMnO₂•0.2Li_{3.5}Sio.₅P_{0.5}O₄) | Chemical shift | −2 | ppm | | | 194 | ppm |
| | Half width | 13 | ppm | | | 857 | ppm |

| Example 11 | Signal integral ratio | 2% | | 98% |
|---|---|---|---|---|
| (0.8LiCrO₂•0.2Li₃VO₄) | Chemical shift | 0 | ppm | 83 |
| | Half width | 15 | ppm | 327 |

TABLE 3

| Analysis sample | | | | |
|---|---|---|---|---|
| (composition) | | Signal 1-1 | Signal 1-2 | Signal 2 |
| Comparative Example 1 | Signal integral ratio | — | — | 100% |
| (LiMnO₂) | Chemical shift | | | 462 ppm |
| | Half width | | | 700 ppm |
| Comparative Example 2 | Signal integral ratio | — | — | 100% |
| (LiCrO₂) | Chemical shift | | | 127 ppm |
| | Half width | | | 299 ppm |
| Comparative Example 3 | Signal integral ratio | 8% | — | 92% |
| (Li₁₂Mn_{0.5}Ti_{0.3}O₂) | Chemical shift | 4 ppm | | 177 ppm |
| | Half width | 42 ppm | | 563 ppm |
| Comparative Example 4 | Signal integral ratio | 28% | 34% | 38% |
| (0.7LiMnO₂•0.3Li₄SiO₄) | Chemical shift | 2 ppm | 37 ppm | −84 ppm |
| | Half width | 15 ppm | 4 ppm | 417 ppm |

### <X Ray Diffraction>

Powder X-ray diffraction measurement was performed on each lithium-containing oxide of the examples and the comparative examples using a powder X-ray diffraction measuring instrument (manufactured by Rigaku Corporation, Ultima IV). In the measurement, the lithium-containing oxide was loaded into a glass plate at room temperature, the glass plate on which the sample was placed was sealed in an airtight sample stage having a beryllium window to avoid air and humidity, and the measurement was performed while the sample remained unexposed to the atmosphere. The measurement was performed using a CuKα-ray source at an output of 40 kV and 40 mA within a diffraction angle 2θ range of 10° to 90° at 0.02° steps and a rate of 2°/minute. The results are shown in Table 4.

TABLE 4

| | 200 peak positions | | Half width | |
|---|---|---|---|---|
| | 2θ/° | | 2θ/° | |
| Example 1 | 43.38 | (2) | 2.42 | (2) |
| Example 2 | 43.713 | (18) | 2.345 | (17) |
| Example 3 | 43.55 | (2) | 2.21 | (2) |
| Example 4 | 43.52 | (3) | 2.70 | (2) |
| Example 5 | 43.44 | (5) | 3.05 | (4) |
| Example 6 | 43.55 | (2) | 3.22 | (3) |
| Example 7 | 43.63 | (5) | 2.98 | (4) |
| Example 8 | 43.68 | (4) | 2.76 | (3) |
| Example 9 | 43.74 | (4) | 2.56 | (3) |
| Example 10 | 43.59 | (6) | 3.32 | (7) |
| Example 11 | 44.134 | (8) | 1.564 | (8) |
| Comparative Example 1 | 43.40 | (3) | 2.78 | (3) |
| Comparative Example 2 | 43.776 | (14) | 2.290 | (12) |
| Comparative Example 3 | 43.6835 | (19) | 0.128 | (2) |
| Comparative Example 4 | 43.36 | (3) | 2.77 | (3) |

<Observation with Transmission Electron Microscope>

Observation was performed under the following measurement conditions.

Device: Analytical electron microscope ARM200F manufactured by JEOL Ltd.

Measurement condition: Accelerating voltage of 200 kV

Sample adjustment: Sample preparation was performed on the lithium-containing oxide of Example 2 by a dry dispersion method under an inert atmosphere.

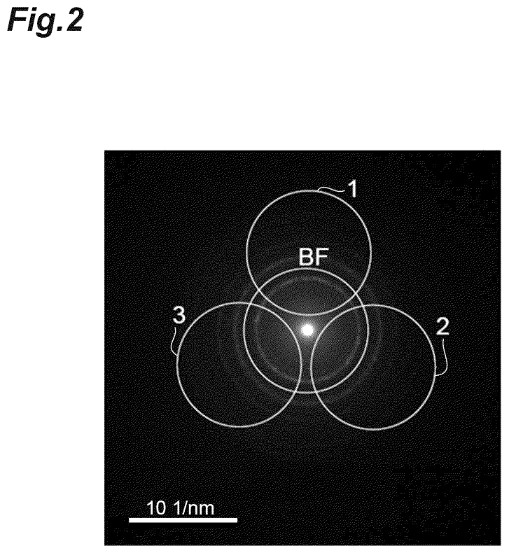

FIG. 2 shows an electron diffraction image of the sample of Example 2. A circle indicated by BF in the drawing is the observation position of a bright field image (not shown). Circles 1, 2 and 3 in FIG. 2 indicate the insertion positions (apertures) of the objective aperture. In FIG. 2, a plurality of bright spots are observed to be arrayed in a ring shape, and halo is observed, and it is thus found that crystal phases and an amorphous phase are present.

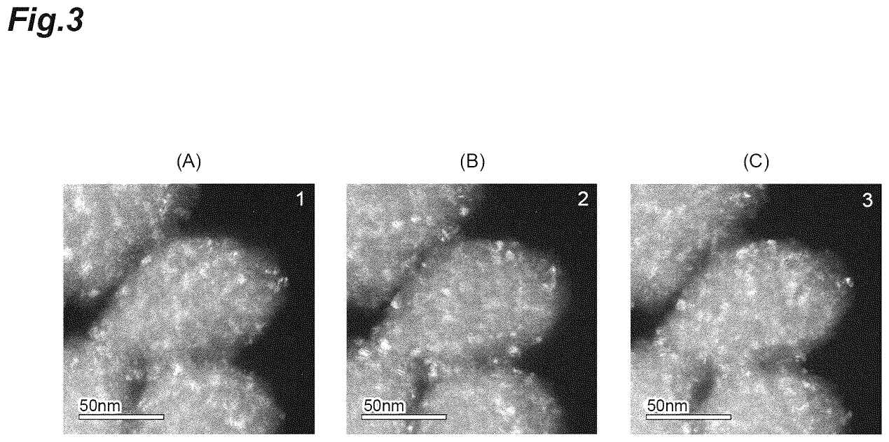

FIG. 3 is a view showing dark field observation images of the sample of Example 2 with the transmission electron microscope. (A), (B) and (C) in FIG. 3 correspond to dark field observation images measured by inserting the objective aperture into the positions 1, 2 and 3 in FIG. 2, respectively. In FIG. 3, white granular structures indicate crystal phases. The crystal phases had grain diameters of approximately 3 to 10 nm in terms of equivalent circle diameter.

1. A lithium-containing oxide having a cationic-disordered rock salt-type structure,
wherein, when a solid ⁷Li-NMR spectrum has been measured, a signal 1 having a half width of more than 0 ppm and 40 ppm or less and a signal 2 having a half width of more than 100 ppm and 2000 ppm or less are observed in a range of a chemical shift of −3000 to 3000 ppm for which a peak of a 1 mol/L LiCl aqueous solution is set to 0 ppm, and
an integrated intensity of the signal 1 relative to a total of integrated intensities of the signal 1 and the signal 2 is more than 0% and 60% or less.

2. The lithium-containing oxide according to claim 1 represented by a formula: 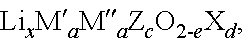
in the formula, 1<x≤1.40, 0.55≤a≤0.90, 0.05≤b≤0.22, 1.8≤x+a+b≤2.2, 0≤c≤0.20, 0≤d<0.70, 0≤e<0.70,
M′ is at least one element selected from the group consisting of Cr, Mn, Fe, Co, Ni and Cu,
M″ is Si or two or more elements of Si and at least one element selected from P, S, V and Ge,
Z is an element except Li, O, M′, M″ and halogen, and
X is a halogen element.

3. The lithium-containing oxide according to claim 1 represented by a formula: 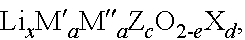
in the formula, 1<x≤1.30, 0.4≤a≤0.85, 0.05≤b≤0.30, 1.8≤x+a+b≤2.2, 0≤c≤0.20, 0≤d<0.70, 0≤e<0.70,
M′ is at least one element selected from the group consisting of Cr, Mn, Fe, Co, Ni and Cu,
M″ is V or two or more elements of V and at least one element selected from P, S, Si and Ge,
Z is an element except Li, O, M′, M″ and halogen, and
X is a halogen element.

4. The lithium-containing oxide according to claim 1 represented by a formula: 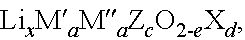
in the formula, 1<x≤1.40, 0.55≤a≤0.90, 0.05≤b≤0.22, 1.8≤x+a+b≤2.2, 0≤c≤0.20, 0≤d<0.70, 0≤e<0.70,
M′ is at least one element selected from the group consisting of Cr, Mn, Fe, Co, Ni and Cu,
M″ is Ge or two or more elements of Ge and at least one element selected from P, S, Si and V,
Z is an element except Li, O, M′, M″ and halogen, and
X is a halogen element.

5. The lithium-containing oxide according to claim 1 represented by a formula: 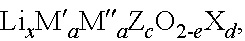
in the formula, 1<x≤1.30, 0.4≤a≤0.85, 0.05≤b≤0.30, 1.8≤x+a+b≤2.2, 0≤c≤0.20, 0≤d<0.70, 0≤e<0.70,
M′ is at least one element selected from the group consisting of Cr, Mn, Fe, Co, Ni and Cu,
M″ is at least two or more selected from the group consisting of Si, P, S, V and Ge,
Z is an element except Li, O, M′, M″ and halogen, and
X is a halogen element.

6. The lithium-containing oxide according to claim 1,
wherein, in powder X-ray diffraction measurement using a CuKα ray at 25° C., a half width of a peak that is observed in a 2θ range of 42° to 46° is 0.5° to 5°.

7. A lithium-containing oxide comprising:
8 to 12 mass % of Li;
35 to 56 mass % of M′ that is at least one element selected from the group consisting of Cr, Mn, Fe, Co, Ni and Cu; and
more than 0 mass % and 15 mass % or less of M″ that is at least one element selected from the group consisting of Si, P, S, V and Ge,
wherein, in powder X-ray diffraction measurement using a CuKα ray at 25° C., a diffraction pattern derived from a cationic-disordered rock salt-type structure is observed,
when a solid ⁷Li-NMR spectrum has been measured, a signal 1 having a half width of more than 0 ppm and 40 ppm or less and a signal 2 having a half width of more than 100 ppm and 2000 ppm or less are observed in a range of a chemical shift of −3000 to 3000 ppm for which a peak of a 1 mol/L LiCl aqueous solution is set to 0 ppm, and
an integrated intensity of the signal 1 relative to a total of integrated intensities of the signal 1 and the signal 2 is more than 0% and 60% or less.

8. An electrode comprising:
the lithium-containing oxide according to claim 1.

9. A battery comprising:
the electrode according to claim 8.

10. The lithium-containing oxide according to claim 1 having an amorphous phase.
